(19) United States
(12) Patent Application Publication
(10) Pub. No.: US 2002/0121248 A1
(43) Pub. Date: Sep. 5, 2002

(54) Animal restraint device

(76) Inventor: Diana Rooks, Tampa, FL (US)

Correspondence Address: WILLIAM S. VAN ROYEN, PETTIS & VAN ROYEN, P.A., 501 E. Kennedy Boulevard, Suite 700, Tampa, FL, 33602, US

(21) Appl. No.: 09/798,674

(22) Filed: Mar. 2, 2001

(51) Int. Cl. A01K 27/00

(52) U.S. Cl. 119/856

(57) ABSTRACT

The present invention relates to a device for restraining animals, particularly pets, preventing them from squeezing through narrow apertures, and thereby escaping from a controlled area. Most simply stated, the device of this invention comprises a harness that is suitable for mounting on a pet and a longitudinally extending member attached thereto. When the harness is mounted on an animal, the member is attached to the harness so that the longitudinal axis of the member is generally horizontal and is generally at right angles to the longitudinal axis of the animal. The member rides on the back of the animal proximal to the shoulder of the animal.

### BACKGROUND OF THE INVENTION

1. Field of the Invention

The present invention relates to a device for restraining animals, particularly pets, restraining them from squeezing through narrow apertures, thereby escaping from a controlled area.

2. Description of the Prior Art

Restraint devices to control animals, such as dogs, cats, rabbits and other pets, are well-known in the art. Certainly dogs and other pets have been required to wear collars so that leashes and licensed tags can be attached. Often to control an animal, one end of a rope or chain is attached to the animal's collar with the other end of the rope or chain being attached to a post, tree or other stable fixture. Other pet barriers have been developed which include electrical shock collars and cable runs. Probably the most popular method for animal control is to fence an area. However, fences have drawbacks, as they frequently have small openings that pets can squeeze through, particularly between the gate and the gate post. The natural tendencies of many animals to dig and burro under obstacles encourage them to dig, burro and squeeze under fences in order to escape.

Prior art patents disclose a number of devices for controlling animals. U.S. Pat. No. 5,787,842 discloses a pet collar to which a plurality of tubes are attached. Both the first end and the second end of each tube is attached to the collar forming a plurality of loops extending outwardly from the collar. These projections may easily become caught on the fencing, or other obstacles found within the fenced area, causing the collar to choke the animal.

The Patent issued to F. L. Johnson, U.S. Pat. No. 3,036,554, discloses a cone shaped metal collar that is attached around the animals neck. The cone shaped attachment is primarily used to prevent the animal from scratching about the head area, but it will obviously also prevent the animal from squeezing through narrow places. This device is awkward and uncomfortable for the animal and would be unsatisfactory for long-term use.

Notwithstanding the existence of such prior art restraining devices, it remains clear that there is a need for a restraining device that does not risk injury to the animal through strangulation, or cause discomfort to the animal by catching on branches, the fence itself or other projections, which may even trap the animal. The device must be sufficiently comfortable for long-term use.

### SUMMARY OF THE INVENTION

The present invention relates to a device for restraining animals, particularly pets, preventing them from squeezing through narrow apertures, thereby escaping from a controlled area. Most simply stated, the device of this invention comprises a harness that is suitable for mounting on a pet and a longitudinally extending member. An attaching means is provided to attach the member to the harness so that when the invention is mounted on an animal the longitudinal axis of the member forms an angle that lies within the range of 45 to 135 degrees with a vertical plane passing through the longitudinal axis of the animal. The backbone of the animal generally lies within that vertical plane. The member rides high on the back of the animal proximal to the shoulder or on the shoulder of the animal.

The invention accordingly comprises an article of manufacturer possessing the features, properties, and the relation of elements which will be exemplified in the article hereinafter described, and the scope of the invention will be indicated in the claims.

### BRIEF DESCRIPTION OF THE DRAWINGS

For a fuller understanding of the nature and objects of the invention, reference should be had to the following detailed description taken in connection with the accompanying drawings, in which:

FIG. 1 is an isometric view the animal restraint device of this invention;

FIG. 2 is a rear elevational view of the animal restraint device of FIG. 1;

FIG. 3 is a detailed cross-sectional view taken along line 3-3 of FIG. 2;

FIG. 4 is detailed front elevational view of the invention illustrating the body removed from the case;

FIG. 5 is a left side elevational view of the invention of FIG. 1, illustrating its attachment to a large animal;

FIG. 6 is an isometric view of the invention of FIG. 1, illustrating its attachment to a small animal;

FIG. 7 is a top plan view of the invention of FIG. 1;

FIG. 8 is a rear elevational view of a second embodiment of the invention of FIG. 1.

FIG. 9 is a cross-sectional view taken along line 9-9 of FIG. 8; and

FIG. 10 is a left side elevational view of a third embodiment of the invention of FIG. 1, illustrating a second harness design.

Similar reference characters refer to similar parts throughout the several views of the drawings. Reference characters for similar parts of additional embodiments are increased by increments of 100.

### DESCRIPTION OF A PREFERRED EMBODIMENT

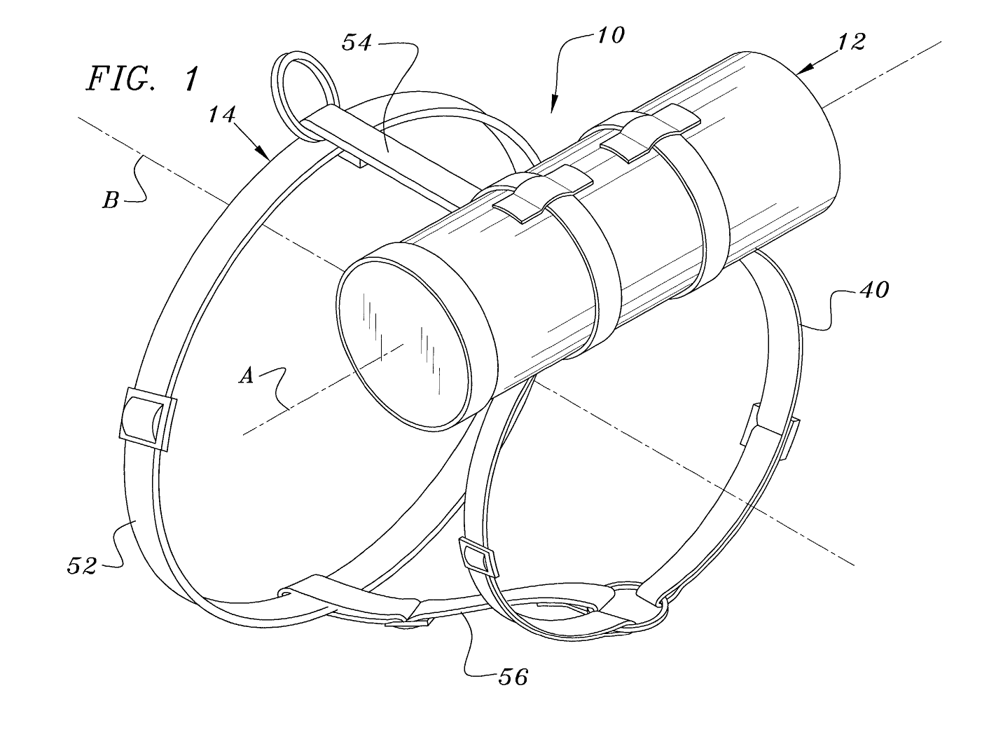

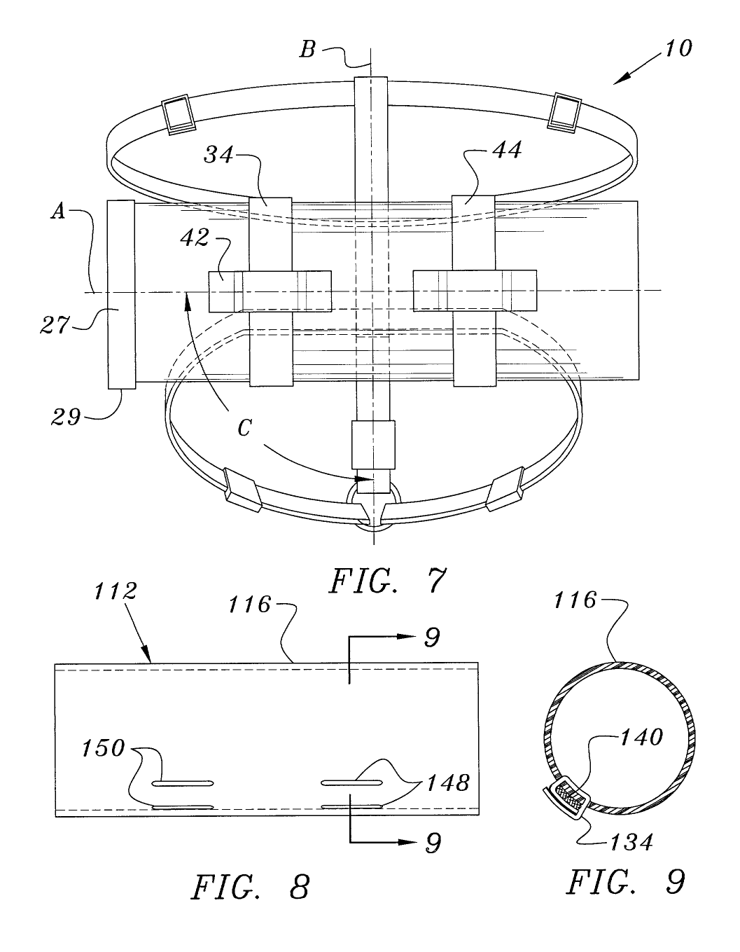

A preferred embodiment for the animal restraint device of this invention is illustrated in the drawing FIGS. 1-7, in which the device is generally indicated as 10. Referring first to the view of FIG. 1, it can be seen that the device 10 comprises a member, shown generally as 12 and a harness shown generally as 14.

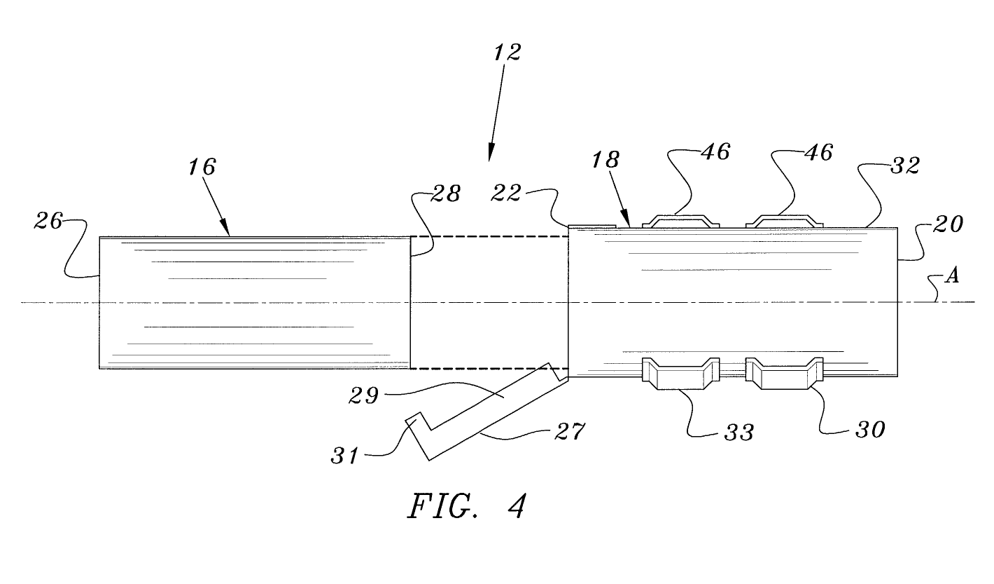

As shown in FIG. 4, the member 12 comprises a longitudinally extending body shown generally as 16 and a cover shown generally as 18. The longitudinally extending member 12 has a longitudinal axis A. The cover 18 has a closed first end 20 and a closable second end 22. The cover 18 is sized and configured to receive the body 16 therein. In a preferred embodiment, the body 16 is hollow defining an interior space 24 therein and further comprising at least one open end, conveniently first end 26, and a second end 28. When the body 16 is inserted within the cover 18, the open end 26 lies adjacent to the closable second end 22 of the cover 18, so that when the second end 22 is open the interior space 24 is accessible through the open end 26 of the body 16. The closable second end 22 has a lid 27 that has a flange 29 whose circumference is greater than the circumference of the cover 18, so that the lid flange 29 fits over and around the second end 22 of the cover 18. The lid 27 may be hinged to the cover 18 by a cloth hinge, or any other well-known hinge mechanism. The lid may be held in the closed position by any well-known method, including but not limited to, a tab 31 having a snap fastener (not shown) or a hook and loop fastener (not shown) thereon, or a zipper (not shown) around the circumference of the lid 27.

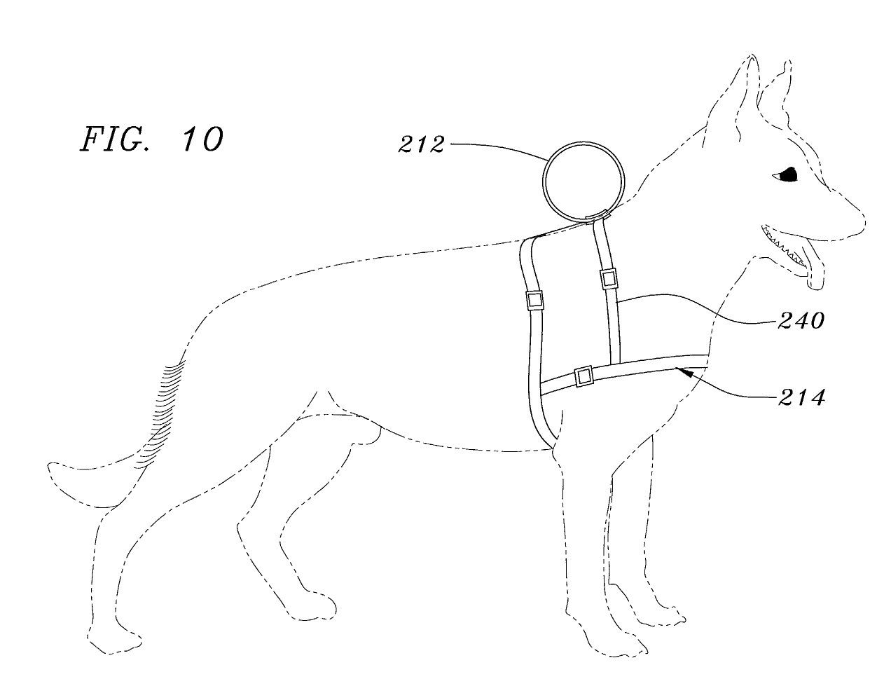

As shown in the drawings, the body 16, in one preferred embodiment, is cylindrical with a circular cross-section; however, in other embodiments the body 16 may have any convenient longitudinal shape, including, but not limited to, cylinders that have a plurality of sides, longitudinally extending bodies of irregular shape, bodies having opposing tapered ends (cigar shape), and bodies having enlarged ends (dumbbell shaped). In other embodiments, the body 16 may have two open end or two closed ends and is directly connected to the harness 14, as shown in FIG. 9.

The member 12 further comprises an attaching means for attachment of the member 12 to the harness 14. In a preferred embodiment when the harness is mounted on the animal, the attaching means ensures that the longitudinal axis A of the member 12 is generally normal to a vertical plane B that passes through the longitudinal axis of the animal, so that the member extends horizontally. In other embodiments, the angle C that the longitudinal axis A of the member 12 forms with the plane B lies within the range of 45 degrees to 135 degrees. These other embodiments still provide effective restraint.

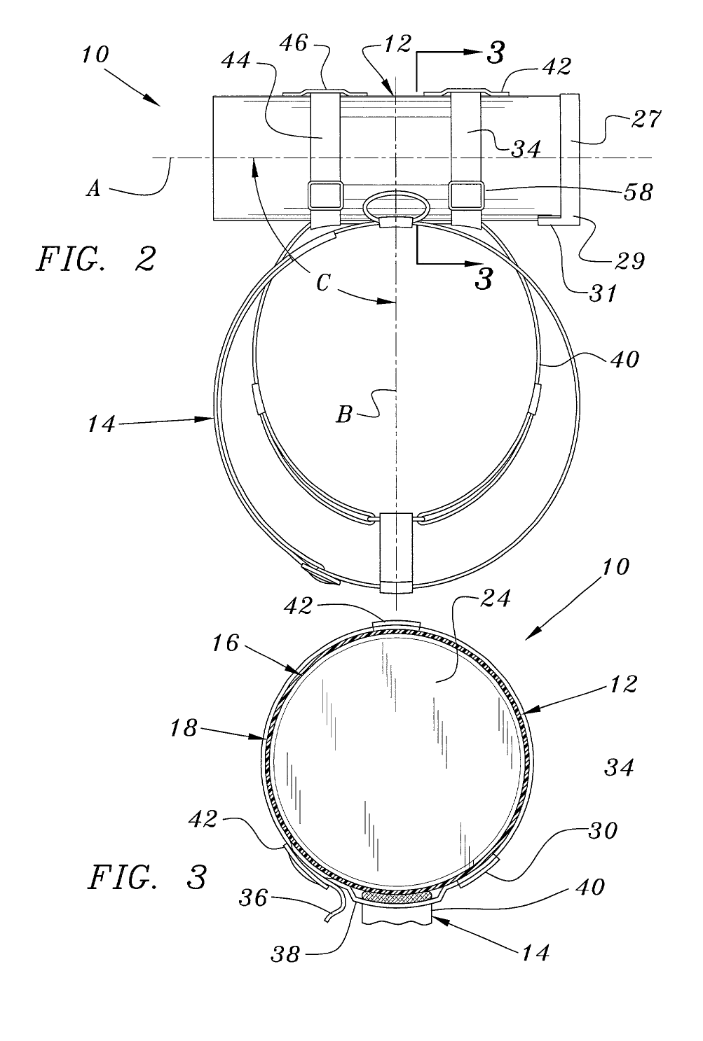

The harness 14 comprises at least one strap 40 that extends about the shoulder of the animal when the harness is mounted thereon. In one preferred embodiment, the attaching means comprises at least one loop 30 that is attached, by stitching, glue, a hook and loop fastener, or other well-known attaching or bonding means, to the side 32 of the cover 18 so that the loop 30 extends generally parallel to the longitudinal axis A of the member 12. A tie 34 having a first end 36 and a second end 38 is used to attach the member 12, to the harness 14. As seen in FIG. 2 and FIG. 3, first end 36 of the tie 34 is passed under a portion of the harness 14, namely harness strap 40, then through the loop 30, around the member 12, and back to the second end 38 of the tie 34 where they are attached to one another. In a preferred embodiment, a buckle 42 is attached to the second end 38 of the tie 34 to which the first end 36 is attached. It is preferred, but not required, that the tie 34 extend around the member 12, as it may be simply passed under the harness strap and then back through the loop so that the first end 36 of the tie 34 can be attached to the second end 38 of the tie 34. In other embodiments, hook and loop fasteners may be used to attach the ends of the ties, or the ties may be permanently stitched to one another and to the cover 18. In the embodiment where the tie 34 is stitched to the cover 18, the strap 40 of the harness 14 must be easily separable from the rest of the harness 14 by a buckle or other means so that strap 40 may be inserted between the tie 34 and the cover 18 and then reattached to the harness 14. In a preferred embodiment, as illustrated in FIG. 2 and FIG. 3, a second loop 42 is attached to the cover 18 proximal to the top of the cover 18, so that it is spaced apart from the first loop 30. The second loop 42 receives the tie 34 therethrough to help hold the tie 34 in proper alignment as it passes around the cover 18. Also in this embodiment, as shown in FIG. 2 and FIG. 3, a second tie 44 and two additional loops, third loop 46 and a fourth loop 33, are used to further stabilize the attachment of the member 12 to the harness 14. The fourth loop 33 receives the second tie 44 therethrough and is located in a position that is similar to loop 30, adjacent to the harness strap 40.

In a second embodiment, the member 112 is comprised only of the body 116, without the cover 18. The attaching means may comprise the same loop and tie method for attachment as disclosed in the embodiment 10 of the device. In this case the loops will have to be glued, riveted or attached by other well known means to the body 116. Another preferred embodiment of the attaching means is disclosed in FIG. 8 and FIG. 9, and comprises at least one pair of slots 148 formed through the body 116. In this case the tie 134 will be passed under the harness 114 and through one of the slots of the pair of slots 148 into the body 116. The tie 134 will then be passed out the other slot of the pair of slots 148, so that the first end of the tie 134 can be attached to the second end of the tie 134, thereby attaching the body 116 to the harness strap 140. Just as in the other embodiment, a second tie 144 (not shown) may be fed in the same fashion through a second pair of slots 150 in the body 116. The first and second ends of the ties are attached to one another by hook and loop fasteners, a buckle, or other means similar to those discussed in relation to the ties 34 and 44.

Many different harness configurations may be used, the preferred harness has at least one strap 40 that extends across the animals body, so that the member 12 may be attached to that harness strap with some stability and extend at generally right angles to the longitudinally extending body of the animal. Certainly, the member 12 may be attached to a strap that extends longitudinally down the back of the animal, but this will not provide a very stable attachment. Harnesses that do not place a harness strap about the neck of the animal are much preferred, to prevent choking of the animal when the body 16 engages an obstruction. In both the harnesses illustrated in FIG. 5 and FIG. 10, the harness strap 40 and 240 to which the member is attached engages the chest of the animal. As shown in FIG. 1, it is also preferred that there be a second circumferential strap 52 that extends about the body of the animal to help stabilize strap 40. The second strap 52 is attached by two connecting straps 54 and 56 to the strap 40. The connecting strap 54 provides additional means for stabilization of the member 12, as when the ties 34 and 44 are passed around the strap 40 on opposing sides of the attachment point of the connecting strap 54 to the strap 40, the member 12 is prevented from sliding around the strap 40. For the most effective use, it is preferred that the member 12 be centered across the animals backbone.

It can also be seen that the member 12 could be attached to the second circumferential strap 52; however, it is preferred that the member 12 be attached to the strap 40 placing the member 12 on the shoulder of the animal rather than on its back. With the member 12 on the shoulder, when the animal ties to squeeze through an aperture it meets resistance before the shoulders have passed through the aperture, encouraging the animal to back up rather than to proceed forward. With the member 12 attached to the back of the animal, the animal will be at least half way through the aperture and will have a tendency to attempt to continue to move forward through the aperture and thus become stuck and perhaps panic.

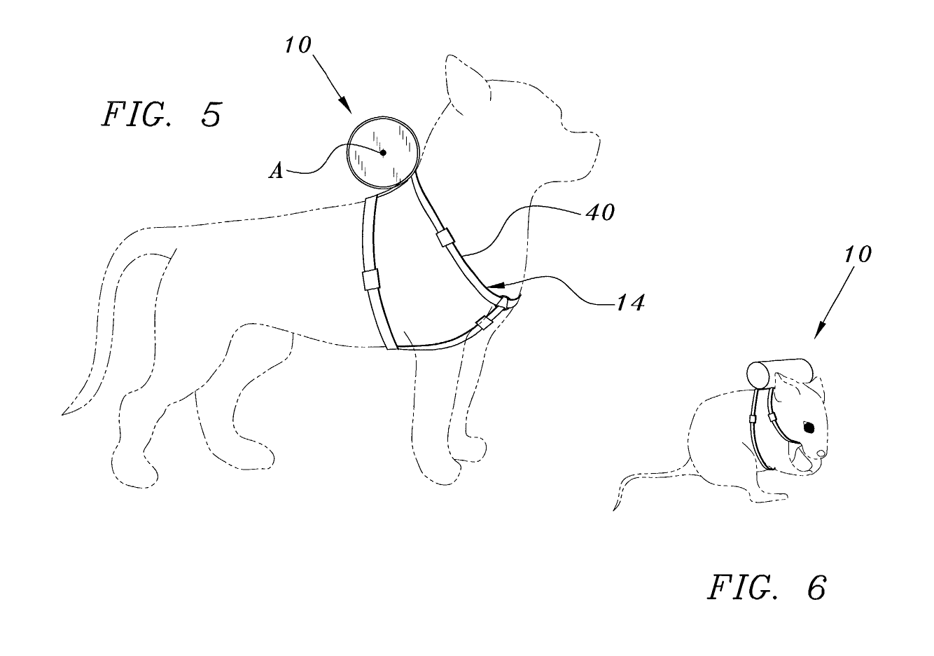

The size of the device 10 will vary based upon the animal on which it is to be mounted. It is preferred that the length of the member 12 be at least as great as the maximum width of the animals body and should not extend much beyond. The diameter of the member should be proportional to the size of the animal, but should not projected above the animal's head when it is held the rack. For example a large German shepherd would require a member having a diameter of 5 inches. As seen in FIG. 6, the device may be used on various sized animals including pet mice, hamsters and so forth.

In a preferred embodiment, the body 16 will be constructed from a plastic tube, the cover 18 will be made from woven material that is generally watertight, such as nylon, and the harness and ties may be made from leather or nylon strapping. Any material that is suitable for the purpose may be used as an alternative.

Having thus set forth a preferred construction of the current invention, is to the remembered that this is but the preferred embodiment. Attention is now invited to a description of the use of the animal restraint device 10. As mentioned previously, the member 12 may be used with any suitable harness, that is, one that does not attach the harness strap 40 solely about the animals neck. When the animal is permitted to run free within a fenced or other containment area, the member 12 is attached to the harness strap 40 that passes over the shoulder proximal to the neck of the animal. In a preferred embodiment the first end of the first tie 34 is passed under the harness strap 40, passed through the loop 42 around the member 12 and through the loop 42. The tie 34 is then passed on around the member 12 until the first end 34 may be passed through the buckle 58 and tightly fastened to the second end 38 of the tie 34. The second tie 44 attaches the member 12 to the harness 14 in the same manner. However, as previously discussed, the second tie 44 is passed around the harness strap 40 on the other side of the point of connection of the first connecting strap 54 and the harness strap 40, so that the connecting strap 54 lies between the two ties 34 and 44. The harness is now attached to the animal in the standard manner. Anytime the animal attempts to squeeze through narrow spaces, the member 12 will engage the adjacent structure resisting the animals forward advance. Most animals will immediately back off when they meet this resistance.

The lid 27 of the member 12 may be opened and the member 12 may be used to carry small objects, such as a leash, treats and the like.

While the foregoing describes a particularly preferred embodiment of the present invention, it is to be understood that numerous variations and modifications of the structure will occur to those skilled in the art. Accordingly, the foregoing description is to be considered illustrative only of the principles of this invention and is not to be considered limitative thereof, the scope of the invention being determined solely by the claims appended hereto.

What is claimed is:

1. An animal restraint device comprising
a harness for removably mounting on an animal, said harness comprising at least one harness strap;
a longitudinally extending member having a longitudinal axis; and
attaching means attaching said member to said harness such that said longitudinal axis of said member forms an angle that lies within the range of 45 to 135 degrees with a vertical plane passing through the longitudinal axis of an animal when the harness is mounted on the animal.

2. An animal restraint device as in claim 1, wherein said longitudinal axis of said member is generally normal to the vertical plane passing through the longitudinal axis of an animal when the harness is mounted on the animal.

3. An animal restraint device as in claim 1, wherein said member comprises a hollow body defining an interior space therein.

4. An animal restraint device as in claim 3, wherein said attaching means comprises at least one pair slots formed in said body, at least one tie, said tie having a first end and a second end, said first end of said tie passing under said at least one harness strap, passing into said body through one of said slots of said pair of slots and passing out of said body through the other one of said pair of slots, said first end of said tie being attached to said second end of said tie.

5. An animal restraint device as in claim 4, wherein said attaching means comprises a second pair of slots formed in said body, and a second tie having a first end and a second end, said first end of said second tie passing under said at least one harness strap, passing into said body through one of said second pair of slots and passing out of said body through the other one of said second pair of slots, said first end of said second tie being attached to said second end of said second tie.

6. An animal restraint device as in claim 3, wherein said member further comprises
a cover that is sized and configured to receive said body therein, said body having at least one open end, said cover having a closed first end and a closable second end, said second end of said cover being adjacent to said at least one open end of said body, such that said interior space of said body is accessible when said closable second end of said cover is open.

7. An animal restraint device as in claim 6 wherein said attaching means comprises at least one loop attached to said cover such that said loop extends generally parallel to said longitudinal axis of said member, a tie having a first end and a second end, said first end of said tie passing under said at least one harness strap, passing through said loop, passing around said cover so that said first end of said tie is attached to said second end of said tie.

8. An animal restraint device as in claim 7, wherein said attaching means further comprises a second loop attached to said cover such that said second loop extends generally parallel to said longitudinal axis of said member, a second tie having a first end and a second end, said first end of said second tie passing under said at least one harness strap, passing through said second loop, and passing around said cover such that said first end of said second tie is attached to said second end of said second tie.
